(19) United States
(12) Patent Application Publication
(10) Pub. No.: US 2012/0169776 A1
(43) Pub. Date: Jul. 5, 2012

(54) METHOD AND APPARATUS FOR CONTROLLING A ZOOM FUNCTION

(75) Inventors: Tero Pekka RISSA, Siivikkala (FI); Kaj Kristian GRONHOLM, Kotka (FI)

(73) Assignee: NOKIA CORPORATION, Espoo (FI)

(21) Appl. No.: 12/980,500

(22) Filed: Dec. 29, 2010

(51) Int. Cl. G09G 5/00

(52) U.S. Cl. 345/676; 345/672

(57) ABSTRACT

In accordance with an example embodiment of the present invention, an apparatus, method, and computer program product for: receiving a first input; initiating a zoom function in response to the first input; receiving a second input during the zoom function, wherein the second input and the first input are independent of each other; and controlling the zoom function based on the second input.

### TECHNICAL FIELD

The present application relates generally to a user interface and especially to controlling a zoom function.

### BACKGROUND

A user interface of an electronic devices typically enables a variety of user inputs and different kinds of user interaction with the electronic devices. Different kinds of user inputs may include, for example, inputting data by means of a hardware key, a touch screen, different kinds of sensors capable of detecting movement and/or orientation of the electronic device, or speech recognition. On the other hand, different kinds of user interaction may include, for example, scrolling, zooming, panning, rotating, moving, copying or pasting items.

### SUMMARY

Various aspects of examples of the invention are set out in the claims.

According to a first aspect of the present invention, there is provided a method comprising receiving a first input, initiating a zoom function in response to the first input, receiving a second input during the zoom function, wherein the second input and the first input are independent of each other and controlling the zoom function based on the second input.

According to a second aspect of the present invention, there is provided an apparatus comprising a processor, memory including computer program code, the memory and the computer program code configured to, working with the processor, cause the apparatus to perform at least the following: receive a first input, initiate a zoom function in response to the first input, receive a second input during the zoom function, wherein the second input and the first input are independent of each other and control the zoom function based on the second input.

According to a third aspect of the present invention, there is provided a computer program product comprising a computer-readable medium bearing computer program code embodied therein for use with a computer, the computer program code comprising code for receiving a first input, code for initiating a zoom function in response to the first input, code for receiving a second input during the zoom function, wherein the second input and the first input are independent of each other and code for controlling the zoom function based on the second input.

According to a fourth aspect of the present invention there is provided an apparatus, comprising means for receiving a first input, means for initiating a zoom function in response to the first input, means for receiving a second input during the zoom function, wherein the second input and the first input are independent of each other and means for controlling the zoom function based on the second input.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an example apparatus operating in accordance with an example embodiment of the invention;

FIG. 2 shows a block diagram of another example apparatus operating in accordance with an example embodiment of the invention;

FIGS. 3a to 3c illustrate a user interface in accordance with an example embodiment of the invention;

FIGS. 4a to 4c illustrate another user interface in accordance with an example embodiment of the invention; and

FIG. 5 illustrates an example method operating in accordance with an example embodiment of the invention.

### DETAILED DESCRIPTION OF THE DRAWINGS

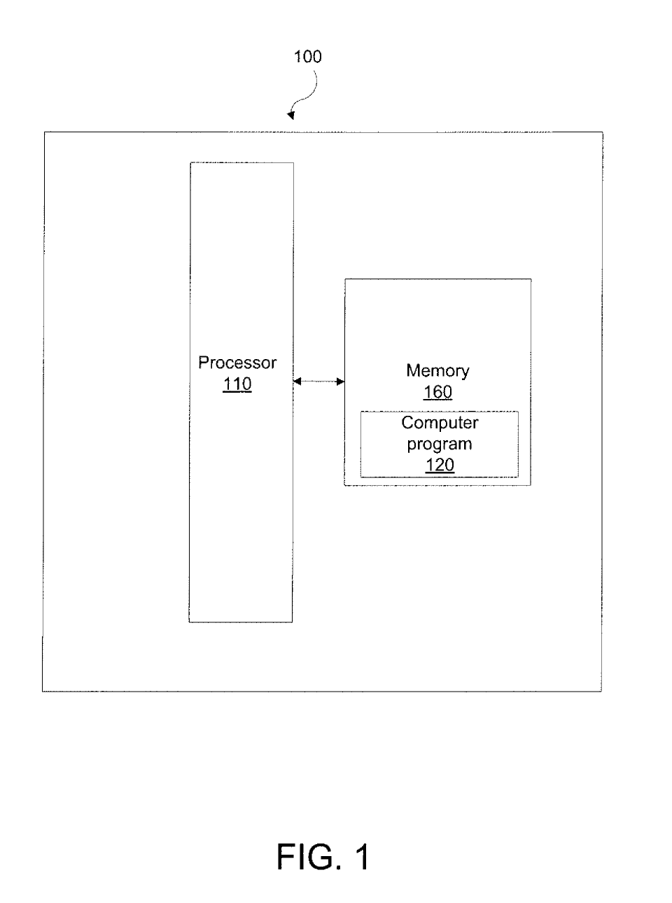

An example embodiment of the present invention and its potential advantages are understood by referring to FIGS. 1 through 5 of the drawings.

The aspects of the disclosed embodiments relate to user operations on an apparatus. In particular, some examples relate to a user interface and especially to controlling a zoom function. In an example embodiment, a zoom function is initiated in response to receiving a first input. In an example embodiment, a second input is received during the zoom function. Further, the zoom function is controlled based at least in part on the second input.

FIG. 1 is a block diagram depicting an apparatus 100 operating in accordance with an example embodiment of the invention. The apparatus 100 may, for example, be an electronic device, such as a chip, a chip-set, and/or the like. Generally, the apparatus 100 includes a processor 110 and a memory 160. In an example embodiment, the apparatus 100 may comprise multiple processors. In an example embodiment, the apparatus 100 may comprise multiple memories.

In the example of FIG. 1, the processor 110 is a control unit that is operatively connected to read from and write to the memory 160. The processor 110 may also be configured to receive control signals to the processor 110 received via an input interface and/or the processor 110 may be configured to output control signals by the processor 110 via an output interface.

In an example embodiment, the memory 160 stores computer program instructions 120 which when loaded into the processor 110 control the operation of the apparatus 100 as explained below. In an example embodiment, the apparatus 100 may comprise more than one memory 160, different kinds of storage devices, and/or the like.

In an example embodiment the processor 110 may be configured to convert the received control signals into appropriate commands for controlling functionalities of the apparatus 100. In an example embodiment, the apparatus 100 may comprise more than one processor.

Computer program instructions 120 for enabling implementations of example embodiments of the invention or a part of such computer program instructions may be downloaded from a data storage unit to the apparatus 100 by the manufacturer of the apparatus 100, by a user of the apparatus 100, or by the apparatus 100 based at least in part on a download program or the instructions can be pushed to the apparatus 100 by an external device. The computer program instructions 120 may arrive at the apparatus 100 via an electromagnetic carrier signal, be copied from a physical entity, such as a computer program product, a memory device or a record medium such as a Compact Disc (CD), a Compact Disk Read-Only Memory (CD-ROM), a Digital Versatile Disk (DVD) or a Bluray disk, and/or the like.

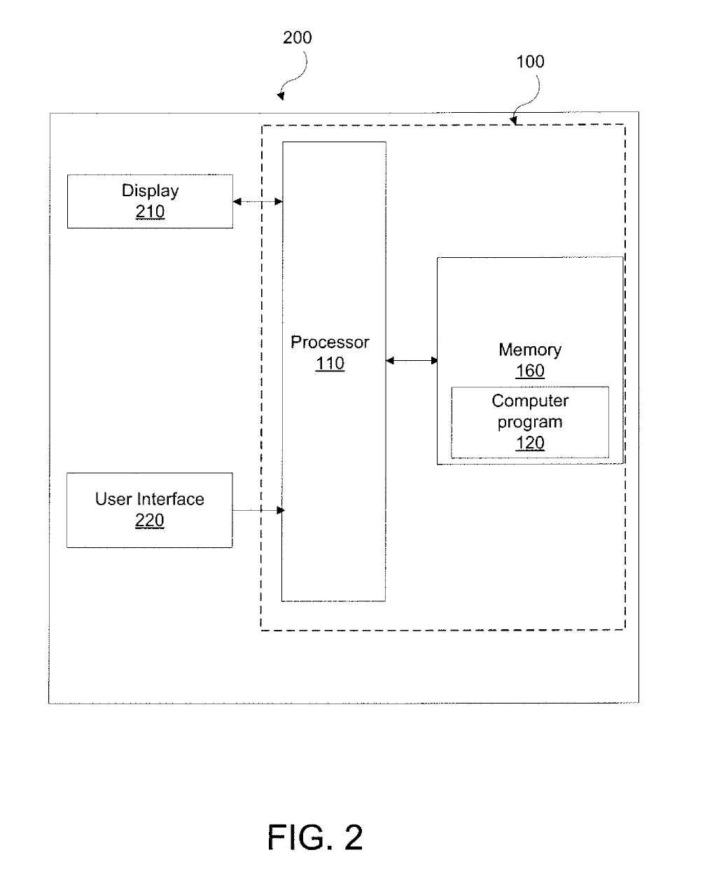

FIG. 2 is a block diagram depicting a another apparatus 200 operating in accordance with an example embodiment of the invention. The another apparatus 200 may be an electronic device such as a hand-portable device, a mobile phone or a Personal Digital Assistant (PDA), a Personal Computer (PC), a laptop, a desktop, a wireless terminal, a communication terminal, a game console, a music player, an electronic book reader (e-book reader), a positioning device, a digital camera, a CD- or DVD-player, a media player, and/or the like.

The another apparatus 200 may include the apparatus 100, a user interface 220 and a display 210. In an example the display 210 may be incorporated into the user interface 220. For example, the user interface 220 may include a touch screen display. In an alternative embodiment, the another apparatus 200 is configured to be connectable to an external display, separate from the another apparatus 200 itself.

In the example of FIG. 2, the user interface 220 is configured to input and access information in the another apparatus 200. According to an example embodiment, the user interface 220 comprises a surface capable of receiving user inputs. The surface may be an input surface such as a touch screen or a touch pad. In an example embodiment, the another apparatus 200 may include both a touch screen and a touch pad or multiple surfaces capable of receiving user inputs. A touch screen may be configured to not only access and/or input information but also to display user interface objects, while a touch pad may be configured to access and/or input information and a separate display may be provided. In an example embodiment, no display is provided. The user interface 220 is configured to receive user inputs input by a user. For example, a user may input and access information by using a suitable input mechanism such as a pointing mechanism, one or more fingers, a stylus or a digital pen.

In an example embodiment, inputting and accessing information is performed by touching the surface such as the surface of a touch screen display 210 or a touch pad. In an example embodiment, proximity of an input mechanism such as a finger or a stylus may be detected and inputting and accessing information may be performed without a direct contact with the surface. In a further example embodiment the surface may be configured to detect multiple at least partially simultaneous touches on the surface.

In an example embodiment, a touch screen, a touch pad, and/or the like may be based at least in part on one or more of different technologies. For example, different touch screen and pad technologies include resistive, capacitive, surface acoustic wave (SAW), infrared, strain gauge, optical imaging, dispersive signal technology, acoustic pulse recognition touch screens, and/or the like. Further, a touch screen, a touch pad, and/or the like may also operate using a combination of different technologies.

In an alternative embodiment, the user interface 220 may also comprise a manually operable control such as a button, a key, a touch pad, a joystick, a stylus, a pen, a roller, a rocker, any suitable input mechanism for inputting and/or accessing information, and/or the like. Further examples include a microphone, a speech recognition system, eye movement recognition system, acceleration, tilt and/or movement based input system.

In the example of FIG. 2 the processor 110 is configured to receive a first input. The first input may be a touch gesture entered on a touch screen or a touch pad, a mouse gesture entered on a touch screen or on a non-touch screen, an instruction or a command entered by means of one or more hardware or virtual keys or an input entered based on a detected movement of the another apparatus 200.

In an embodiment, the processor 110 is configured to initiate a zoom function in response to the first input. A zoom function may comprise scaling content in terms of making the content larger or smaller in size. For example, content includes a map wherein zooming may include making one or more items presented on the map larger or smaller. The processor 110 may be configured, for example, to zoom continuously until the zoom function is interrupted or terminated, or to zoom for a pre-determined time.

The processor 110 may also be configured to receive information on removal of the first input after initiating the zoom function and to keep the zoom function active after the removal of the first input. For example, a user may initiate a zoom function by a touch gesture entered on a touch screen and the zoom function is kept active by the processor 110 after removal or terminating of the touch gesture. As another example, a user may initiate a zoom function by a mouse gesture detected by the processor 110 and the zoom function is kept active by the processor 110 after terminating the mouse gesture. In other words, the processor 110 is configured to leave the zoom function running after receiving information on a termination of the first input.

According to an example embodiment, the processor 110 is configured to initiate the zoom function in response to receiving information on a dedicated touch gesture. A touch gesture may include, for example, a single touch gesture such as a tap, a stroke or a flick gesture. In an example embodiment, the zoom function is initiated by a combination of a first gesture and a second gesture. For example, the first gesture may be a long tap and the second gesture may be a flick gesture. In an example embodiment, the processor 110 is configured to enter a dedicated zoom mode in response to receiving information on a first gesture and to cause initiating the zoom function in response to receiving the second gesture.

According to an example embodiment, the processor 110 is configured to provide a control area for initiating zooming. The control area may comprise a virtual area provided on a touch screen. For example, the control area may comprise a virtual zoom wheel, a virtual zoom bar, an icon, a dedicated area or any combination thereof. As another example, the control area may comprise a virtual area provided on a non-touch screen. In an example embodiment, the zoom function is initiated by a combination of a first gesture and a second gesture. For example, the processor 110 may be configured to provide the control area in response to receiving information on a first gesture and to cause initiating the zoom function in response to receiving information on the second gesture within the control area.

In an example embodiment, the processor 110 is configured to initiate a zoom function with momentum in response to the first input and gradually slow down the zooming until the zooming stops. In an example embodiment, a zoom in function with momentum comprises initiating the zoom function in response to a first input and gradually making content larger in size without further inputs as long as the zoom in function continues. According to an example embodiment, a zoom out function with momentum comprises initiating the zoom function in response to a first input gradually making content smaller in size without further inputs as long as the zoom out function continues. A zoom function with momentum may thus comprise initiating the zoom function in response to a first input and gradually changing the size of content without further inputs as long as the zoom in function continues. According to a further example embodiment, the processor 110 is configured to determine an initial momentum for a zoom function based on a characteristic of the first input. For example, the processor 110 may be configured to determine an initial momentum based on the speed, touch pressure, intensity of the first input, or any combination thereof.

According to an example embodiment, the processor 110 is configured to receive a second input during the zoom function. The second input may be, for example, a touch gesture entered on a touch screen or a touch pad, a mouse gesture, an instruction or a command entered by one or more hardware or virtual keys or an input entered based on a detected movement of the another apparatus 200. A touch gesture may include, for example, a single touch gesture such as a tap, a stroke, a flick gesture or a combination of touch gestures.

In an example embodiment, receiving a second input during the zoom function comprises receiving the second input after initiating the zoom function. In an example embodiment, receiving a second input during the zoom function comprises receiving the second input after initiating the zoom function, but before terminating or interrupting the zoom function by a user. In a further example embodiment, receiving a second input during the zoom function comprises receiving the second input after initiating the zoom function, but before terminating or interrupting the zoom function by the processor 110. In yet a further example embodiment, receiving a second input during the zoom function comprises receiving the second input in a time period between initiating and terminating the zoom function by the processor 110.

In an example embodiment, the processor 110 of the example of FIG. 2 is configured to control the zoom function based on the second input. According to an example embodiment, controlling the zoom function comprises changing the location of a centre of the zoom.

In an example, the first input and the second input may be completely separate from each other. In an example, the first input and the second input may be independent of each other. For example, the first input may include initiating and terminating the first input, while the second input may include at least initiating the second input. In an example, the first input and the second input may be associated with a first independent operation and a second independent operation, respectively. In an example, the first independent operation and the second independent operation may be different operations. For example, the first input may be associated with zooming and the second input may be associated with panning. In an example, the first input may be associated with a first operation and the second input may provide sub-controls for the first operation. For example, the first input may initiate a zoom operation and the second input may provide for controlling the center of the zoom. Thus, in an example, the first input and the second input may be independent from each other while the second input may provide for controlling an operation associated to the first input. In an example, the first input and the second input may be independent from each other while the second input may provide for controlling an operation associated to the first input without discontinuing the operation associated to the first input. For example, the first input may cause initiating zooming and the second input may enable panning while zooming without discontinuing the zooming.

In an example embodiment, the processor 110 is configured to interrupt or terminate the zoom function in response to receiving information on a third input.

Referring back to the example of FIG. 2, the another apparatus 200 may also include an output device. According to an example embodiment, the output device is a display for presenting visual information such as user interface objects for a user. The display is configured to receive control signals provided by the processor 110. However, it is also possible that the another apparatus 200 does not include a display or the display is an external display, separate from the another apparatus 200 itself. According to an example embodiment the display may be incorporated within the user interface 220.

In an alternative embodiment, the another apparatus 200 may include an output device such as a tactile feedback system for presenting tactile and/or haptic information for a user. The tactile feedback system may be configured to receive control signals provided by the processor 110. The tactile feedback system may be configured to indicate a completed operation or to indicate selecting an operation, for example. In one embodiment a tactile feedback system may cause the another apparatus 200 to vibrate in a certain way to inform a user of an activated and/or completed operation.

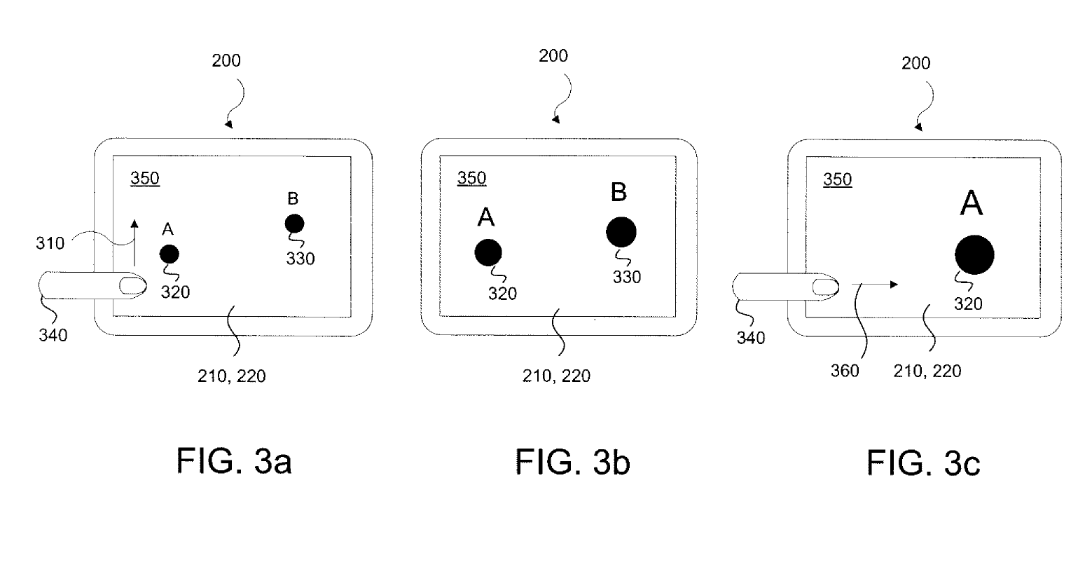

FIGS. 3a to 3c illustrate an example user interface incorporating aspects of the disclosed embodiments. An another apparatus 200 comprises a surface configured to receive user inputs. In this example, the surface is a touch screen display 210 incorporated within the user interface 220, which allows inputting and accessing information via the touch screen display 210. The touch screen display 210 is configured to present graphical user interface objects. The example another apparatus 200 of FIG. 3 may also comprise one or more keys and/or additional and/or other components.

In the example of FIGS. 3a to 3c content 350 is presented on the touch screen display 210 to a user. In the example of FIGS. 3a to 3c, the content comprises a map with map items A 320 and B 330.

In the example of FIG. 3a, a user initiates a zoom function by a first input. The first input may comprise, for example, a touch gesture entered by a finger 340. The touch gesture may comprise, for example, a single gesture or a combination of a first gesture and a second gesture. In an example embodiment, the first input may comprise any combination of touch gestures entered on the another apparatus 200 without releasing the touch from the touch screen 210. In this example, the touch gesture comprises a combination of a long tap and a flick gesture.

The long tap gesture in FIG. 3a comprises keeping the finger 340 substantially stationary for a pre-determined period of time on the touch screen display 210. For example, a long tap may comprise keeping the finger substantially stationary until a pre-determined threshold value has been reached. A threshold value may be, for example, 0.5 seconds, 1 second, 1.5 seconds or 2 seconds. In other example embodiments, a threshold value for the long tap may be set by a user or may be adapted based on user behavior (for example based on historical data indicating the length of previous taps).

According to an example embodiment, the processor such as processor 110 of FIG. 2 is configured to cause the apparatus to enter a dedicated zoom mode in response to receiving information on the first gesture. The dedicated zoom mode may be indicated to the user by means of, for example, graphical, audible, tactile/haptic indication or any combination thereof. For example, a change to a dedicated zoom mode may be indicated by means of an icon presented on the touch screen display 210.

According to an example embodiment, the processor is configured to cause the apparatus to initiate a zoom function in response to receiving information on the second gesture in the dedicated zoom mode.

In an example embodiment, the second gesture may also indicate a zooming characteristic. The zooming characteristic may comprise information on whether the content 350 is to be made larger in size or smaller in size. In an example embodiment, the processor is configured to determine a zooming characteristic based on the direction of the second gesture. For example, a vertical flick gesture towards the top edge of the another apparatus 200 may indicate an instruction to make the content 350 larger is size. A vertical flick gesture towards the bottom edge of the another apparatus 200 may indicate an instruction to make the content 350 smaller in size. Alternatively, a horizontal flick gesture to the right or left edge of the apparatus may indicate an instruction to making the content 350 larger or smaller in size, respectively, or vice versa.

In an example embodiment, the second gesture is a flick gesture that comprises a fast drag by a stylus or a finger that is lifted off the touch screen display 210 while still in motion. In such embodiments the flick gesture thus enables zooming with momentum, in that zooming continues even after the finger or the stylus is lifted. In the example of FIG. 3a a user enters a vertical flick towards the top of the another apparatus 200 as illustrated by the arrow 310. It should be noted that in the example of FIG. 3a the arrow 310 is presented for illustrative purposes only and is not visible to the user. However, different kinds of visualization and feedback may be provided for the user to indicate that the first input, the first gesture and/or the second gesture has been received and/or activated by the processor.

As explained above, the processor may be configured to initiate a zoom function in response to a first input, wherein the first input comprises a combination of a first gesture and a second gesture. Therefore, the first input may comprise one or more sub-functions for initiating the zoom function. For example, the first input may comprise a first gesture to enter a dedicated zoom mode and a second gesture to initiate a zoom function in the dedicated zoom mode. In an example embodiment, the processor is configured to receive information on a first input comprising sub-functions for initiating a zoom function. In an example embodiment, the processor may be configured to receive information on the first input, analyze the first input and identify sub-functions in the first input for initiating the zoom function. In a further example embodiment, the processor may be configured to receive information on the first input, analyze the first input, identify and extract sub-functions from the first input for initiating the zoom function. For example, the processor may receive information on a first input comprising a combination of a long tap gesture and a flick gesture entered on a touch screen 210. The processor is further configured to cause entering a dedicated zoom mode in response to the long tap gesture and initiate a zoom function in the dedicated zoom mode in response to the flick gesture.

In the example of FIG. 3a, the zoom function was initiated by a finger 340. In other example embodiments, a user may initiate a zoom function by entering a command by means of any suitable pointing device such as a stylus, a digital pen or a mouse. In addition, in the example of FIG. 3a the zoom function was initiated by a touch gesture. In other example embodiments, the zoom function may be initiated by a mouse gesture, a hovering gesture i.e. no direct contact with a touch screen is required or a hand gesture detected by a camera.

The example of FIG. 3b illustrates a situation after initiating the zoom function in FIG. 3a. The processor is configured to continue zooming the content 350 after termination or interruption of the touch gesture is detected. In other words, the processor is configured to initiate a zoom function with momentum in response to the first input.

In an example embodiment, the momentum may be dependent on a characteristic of the first input such as the applied pressure, intensity, speed or a direction of the first input. In an example embodiment, the momentum may be independent of a characteristic of the first input. In an example embodiment, the momentum has a default value. In an example embodiment, the processor is configured to cause slowing down the zoom function. In an example embodiment, the processor is configured to cause interrupting or terminating the zoom function in response to a user input.

Referring back to FIG. 3b, the map items A 320 and B 330 have been made larger in size compared to the map items A 320 and B 330 in the example of FIG. 3a, in response to detecting a vertical flick gesture 310 towards the top edge of the another apparatus 200. According to an example embodiment, the processor is configured to receive information on a characteristic of the first input. For example, the processor may be configured to detect a direction of a flick gesture and zoom the content 350 accordingly. In this example, a vertical flick gesture towards the top edge of the apparatus causes scaling the map items A and B larger in size, whereas a vertical flick gesture towards the bottom edge of the apparatus causes scaling the map items A and B smaller in size.

The example of FIG. 3c illustrates an embodiment where zooming is still continued and as a result the map item A 320 (and B 330) is made even larger in size compared to the map item A 320 (and B 330) in the example of FIG. 3b. The processor is configured to receive a second input during the zoom function and the processor is further configured to control the zoom function based on the second input. The second input is used for controlling the center of the zoom. In the example of FIG. 3c the second input comprises a touch gesture for panning the content 350 to the left as indicated by the arrow 360. It should be noted that the arrow 360 is presented for illustrative purposes only and is not visible to the user. However, different kinds of visualization and feedback may be provided for the user to indicate that the second input has been has been received and/or activated by the processor.

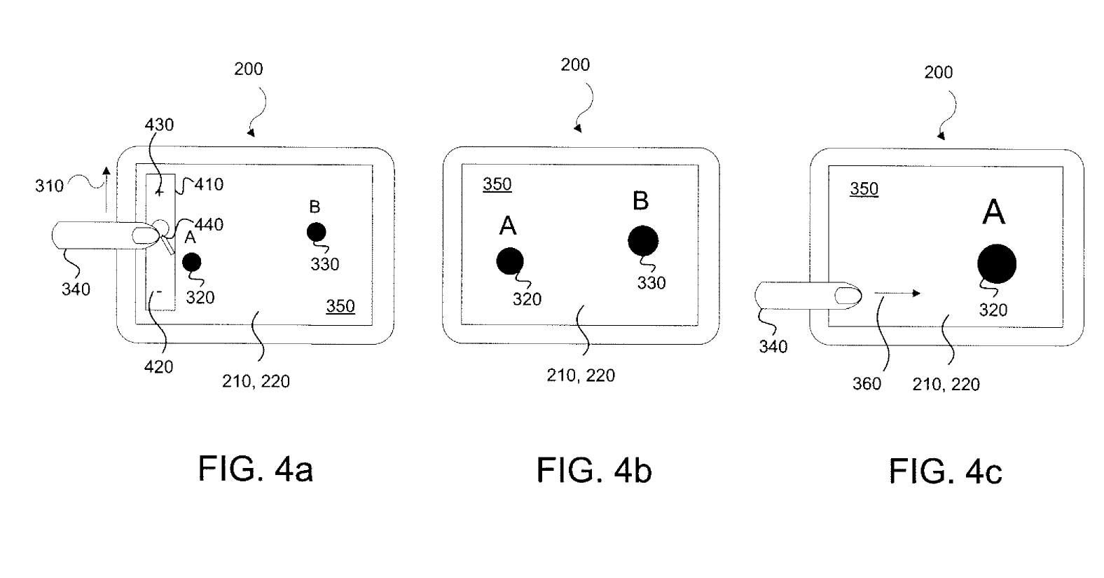

FIGS. 4a to 4d illustrate another example user interface incorporating aspects of the disclosed embodiments. Similarly, to FIGS. 3a to 3c, an another apparatus 200 comprises a surface configured to receive user inputs. In this example, the surface is a touch screen display 210 incorporated within the user interface 220, which allows inputting and accessing information via the touch screen display 210. The touch screen display 210 is configured to present user interface objects. The example another apparatus 200 of FIG. 4 may also comprise one or more keys and/or additional and/or other components.

Similarly to the example of FIGS. 3a to 3c, content 350 is presented on the touch screen display 210 to a user. As in the example of FIGS. 3a to 3c, the content comprises a map with map items A 320 and B 330.

In the example of FIG. 4a, a user initiates a zoom function by a first input. The first input may comprise, for example, a touch gesture entered by a finger 340. The touch gesture may comprise, for example, a single gesture or a combination of a first gesture and a second gesture. In an example embodiment, the first input may comprise any combination of touch gestures entered on the another apparatus 200 without releasing the touch from the touch screen 210. In this example, the touch gesture comprises a long tap.

The long tap gesture in FIG. 4a comprises keeping the finger 340 substantially stationary for a pre-determined period of time on the touch screen display 210. For example, a long tap may comprise keeping the finger stationary until a pre-determined threshold value has been reached. A threshold value may be, for example, 0.5 seconds, 1 second, 1.5 seconds or 2 seconds. In other example embodiments, a threshold value for the long tap may be set by a user or may be adapted based on user behavior.

According to an example embodiment, the processor such as processor 110 of FIG. 2 is configured to cause the apparatus to enter a dedicated zoom mode in response to receiving information on the first gesture. The dedicated zoom mode may be indicated to the user by means of, for example, graphical, audible, tactile/haptic indication or any combination thereof. For example, a change to a dedicated zoom mode may be indicated by means of an icon presented on the touch screen display 210.

In the example of FIG. 4a, the processor is configured to enter a dedicated zoom mode in response to receiving information on the first gesture (e.g. a long tap) and to provide a control area for initiating zooming. In the example of FIG. 4a, the virtual control area comprises a virtual zoom bar 410.

According to an example embodiment, the virtual zoom bar 410 comprises a virtual area on the touch screen display 210 configured to receive user inputs. The processor may further be configured to receive information on a second gesture entered within the virtual zoom bar 410. For example, a drag or a swipe gesture towards the “+” sign 430 illustrated within the virtual zoom bar 410 may cause zooming the content 350 in terms of making the content 350 larger in size. On the other hand, a drag or a swipe gesture towards the “−” sign 420 illustrated within the virtual zoom bar 410 may cause zooming the content 350 in terms of making the content 350 smaller in size. In an example embodiment, a user may first perform a drag or a swipe gesture towards the “+” sign 430 and the towards the “−” sign 420 and/or vice versa and the processor is configured to cause zooming the content 350 based a zooming condition fulfilled upon terminating the drag or swipe gesture. For example, if the user first performs a drag gesture towards the “+” sign 430, then continues the drag gesture towards the “−” sign 420 and then terminates the drag gesture, the zooming condition fulfilled upon terminating the drag gesture is the drag gesture towards the “−” sign 420. Therefore, the processor causes zooming the content 350 in terms of making the content smaller in size.

According to an example embodiment, the virtual zoom bar 410 may comprise a first dedicated area for zooming in and a second dedicated area for zooming out. Here, zooming in refers to making one or more items larger in size and zooming out refers to making one or more items smaller in size. The processor is configured to initiate a zoom function associated to a dedicated area in response to receiving information on an input on a dedicated area.

According to an example embodiment, the processor is configured to receive information on a characteristic of an input entered within the zoom bar 410 and initiate zooming of the content 350 according to the detected characteristic. The characteristic may be, for example, a direction of a gesture, a speed of a gesture, a touch pressure of a gesture or any combination thereof. For example, a touch gesture towards the top of the touch screen display 210 may cause zooming the content 350 larger in size. According to a further example embodiment, the processor is configured to receive information on a characteristic of a touch gesture entered on the zoom bar 410 upon termination of the touch gesture. Termination of a touch gesture may comprise, for example, information on releasing the touch gesture from the touch screen, terminating or interrupting the touch gesture or extending the touch gesture outside the zoom bar 410 or any combination thereof.

The virtual zoom bar 410 in the example of FIG. 4a may have various different shapes and/or sizes and/or positions on the touch screen display 210. In addition, the zoom bar 410 may comprise different kinds of guidance on one or more functions of the zoom bar 410 such as a magnifier icon 440 indicating to the user that the zoom bar 410 may be used for controlling the size of the content 350. In addition, the processor may be configured to cause providing haptic/tactile feedback on functions of the zoom bar 410.

In the example of FIG. 4a, the control area comprises a virtual zoom bar. In an example embodiment, the control area may comprise a virtual zoom wheel such as a circular area or a circular strip on which a user may enter on gesture such as a flick gesture, a drag gesture or a swipe gesture. A virtual zoom wheel may further be configured to zoom content larger in size in response to detecting a circular gesture in a clockwise direction within the virtual zoom wheel and to zoom content smaller in size in response to detecting a circular gesture in a counter-clockwise direction within the virtual zoom wheel or vice versa.

Similarly to the example of FIGS. 3a to 3c, the second gesture may comprise a flick gesture that comprises a fast drag by a stylus or a finger that is lifted off the touch screen display 210 while still in motion. A flick gesture enables zooming with momentum. In other words, zooming continues even after the finger or the stylus is lifted.

In the example of FIG. 4a a user enters a vertical flick towards the “+” sign 430 within the zoom bar 410 as illustrated by the arrow 310. It should be noted that in the example of FIG. 4a the arrow 310 is presented for illustrative purpose only and is not visible to the user. However, different kinds of visualization and feedback may be provided for the user to indicate that the first input, the first gesture and/or the second gesture has been received and/or activated by the processor.

As explained above, the processor may be configured to initiate a zoom function in response to a first input, wherein the first input comprises a combination of a first gesture and a second gesture. Therefore, the first input may comprise one or more sub-functions for initiating the zoom function. For example, the first input may comprise a first gesture to activate a virtual control area and a second gesture within the control area to initiate a zoom function.

In the example of FIG. 4a, the zoom function was initiated by a finger 340. In other example embodiments, a user may initiate a zoom function by entering a command by means of any suitable pointing device such as a stylus, a digital pen or a mouse. In addition, in the example of FIG. 4a the zoom function was initiated by a touch gesture. In other example embodiments, the zoom function may be initiated by a mouse gesture, a hovering gesture i.e. no direct contact with a touch screen is required or a hand gesture detected by a camera.

Similarly to the example of FIG. 3b, FIG. 4b illustrates a situation after initiating the zoom function in FIG. 4a. The processor is configured to continue zooming the content 350 after a release of the touch gesture is detected. In other words, the processor is configured to initiate a zoom function with momentum in response to the first input.

In an example embodiment, the momentum may be dependent on a characteristic of the first input such as the applied pressure, intensity, speed or a direction of the first input. In an example embodiment, the momentum may be independent of a characteristic of the first input. In an example embodiment, the momentum has a default value. In an example embodiment, the processor is configured to cause slowing down the zoom function. In an example embodiment, the processor is configured to cause interrupting or terminating the zoom function in response to a user input.

Referring back to FIG. 4b, the map items A 320 and B 330 have been made larger in size compared to the map items A 320 and B 330 in the example of FIG. 4a, in response to detecting a vertical flick gesture 310 towards the “+” sign 430 within the zoom bar 410.

The example of FIG. 4c illustrates an embodiment where zooming is still continued and as a result the map item A 320 (and B 330) is made even larger in size compared to the map item A 320 in the example of FIG. 4b. The processor is configured to receive a second input during the zoom function and the processor is further configured to control the zoom function based on the second input. The second input is used for controlling the center of the zoom. In the example of FIG. 4c the second input comprises a touch gesture for panning the content 350 to the left as indicated by the arrow 360. It should be noted, that the arrow 360 is presented for illustrative purposes only and is not visible to the user. However, different kinds of visualization and feedback may be provided for the user to indicate that the second input has been has been received and/or activated by the processor.

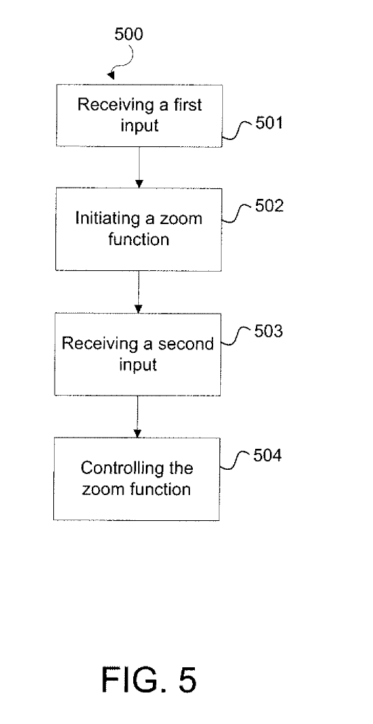

FIG. 5 illustrates an example method 500 incorporating aspects of the previously disclosed embodiments.

The method 500 starts with the reception at 501 of a first input by a processor, such as processor 110 of FIG. 2. The first input may be, for example, a touch gesture on a touch screen or a mouse gesture either on a touch screen or on a non-touch screen. The first input may comprise an input command to initiate a function; for example, the first input may comprise initiating a zoom function, a panning function, a rotating function, a copy function, a paste function or a move function. The first input may instead comprise one or more sub-functions for initiating a zoom function; for example, the first input may comprise an instruction to enter a dedicated zoom mode or to provide a control area for zooming. In addition, the first input may comprise an instruction to initiate the zoom function in the dedicated zoom mode or within the control area.

The processor may be configured to initiate at 502 a zoom function in response to the first input. The zoom function may comprise scaling the size of at least a part of a user interface. A zoom function may include making one or more user interface elements larger or smaller in size. For example, by means of a touch gesture on a touch screen at least a part of a user interface may be made larger in size.

The processor may further be configured to receive at 503 a second input during the zoom function and to control at 504 the zoom function based on the second input. The second input may comprise an input command to initiate a function. For example, the second input may comprise initiating a zoom function, a panning function, a rotating function, a copy function, a paste function or a move function.

In an example embodiment, controlling the zoom function comprises changing the location of a centre of the zoom. For example, during the zoom function the second input may initiate a panning function and while the zoom function continues the panning function changes the centre of the zoom.

According to some example embodiments, the zoom function gradually slows down. For example, the processor may be configured to decrease the speed of zooming at set time intervals until the speed of zooming is zero. According to some example embodiments, the processor may be configured to interrupt the zoom function in response to a third input. For example, the processor may be configured to cause the zoom function to continue until it is stopped by a user. The zoom function may be stopped, for example, by a dedicated touch gesture.

In an example embodiment, the processor is configured to detect termination or interruption of the first input after initiating the zoom function. In an example embodiment the processor is configured continue the zoom function after receiving an indication of termination or interruption of the first input after initiating the zoom function.

The zoom function may be initiated by a touch gesture. The touch gesture may include, for example, a tap, a long tap, a stroke, a swipe, a flick, a fling, a free form gesture or any combination thereof. According to an example embodiment, the zoom function is initiated by a combination of a first gesture and a second gesture. For example, the first gesture may be a long tap and the second gesture may be a flick gesture. In an example embodiment, the first gesture may cause the processor to enter a dedicated zoom mode and the second gesture may cause the processor to initiate the zoom function. In an example embodiment, the first gesture may cause the processor to provide a control area for initiating zooming and the second gesture may cause the processor to initiate the zoom function. The control area may comprise a virtual area provided on a touch screen. For example, the control are may comprise a virtual wheel, a virtual zoom bar, an icon, a dedicated area, any combination thereof, and/or the like.

Without in any way limiting the scope, interpretation, or application of the claims appearing below, a technical effect of one or more of the example embodiments disclosed herein is enabling two control functions simultaneously. For example, a user can simultaneously zoom and pan content on a display. Another technical effect of one or more of the example embodiments disclosed herein is enabling single handed usage of an apparatus for controlling two different functions simultaneously.

Embodiments of the present invention may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with an example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving a first input;
initiating a zoom function in response to the first input;
receiving a second input during the zoom function, wherein the second input and the first input are independent of each other; and
controlling the zoom function based on the second input.

2. A method according to claim 1, wherein controlling the zoom function comprises changing the location of a centre of the zoom.

3. A method according to claim 1, wherein the zoom function gradually slows down.

4. A method according to claim 1, further comprising receiving information on removal of the first input after initiating the zoom function and keeping the zoom function active after the removal of the first input.

5. A method according to claim 1, wherein the zoom function is initiated by a combination of a long tap and a flick gesture on a touch screen.

6. A method according to claim 1, further comprising interrupting the zoom function in response to a third input.

7. A method according to claim 1, further providing a control area for initiating zooming, wherein the control area comprises a virtual area provided on a touch screen display.

8. An apparatus, comprising:
a processor,
memory including computer program code, the memory and the computer program code configured to, working with the processor, cause the apparatus to perform at least the following:
receive a first input;
initiate a zoom function in response to the first input;
receive a second input during the zoom function, wherein the second input and the first input are independent of each other; and
control the zoom function based on the second input.

9. An apparatus according to claim 8, wherein the memory and the computer program code are configured to, working with the processor, cause the apparatus to control the zoom function by changing the location of a centre of the zoom.

10. An apparatus according to claim 8, wherein the memory and the computer program code are configured to, working with the processor, cause the apparatus to gradually slow down the zoom function.

11. An apparatus according to claim 8, wherein the memory and the computer program code are configured to, working with the processor, cause the apparatus to receive information on removal of the first input after initiating the zoom function and to keep the zoom function active after the removal of the first input.

12. An apparatus according to claim 8, wherein the memory and the computer program code are configured to, working with the processor, cause the apparatus to initiate the zoom function by receiving information on a combination of a long tap and a flick gesture on a touch screen.

13. An apparatus according to claim 8, wherein the memory and the computer program code are configured to, working with the processor, cause the apparatus to interrupt the zoom function in response to a third input.

14. An apparatus according to claim 8, wherein the memory and the computer program code are configured to, working with the processor, cause the apparatus to provide a control area for initiating zooming, wherein the control area comprises a virtual area provided on a touch screen display.

15. A computer program product comprising a computer-readable medium bearing computer program code embodied therein for use with a computer, the computer program code comprising:
code for receiving a first input;
code for initiating a zoom function in response to the first input;
code for receiving a second input during the zoom function, wherein the second input and the first input are independent of each other; and
code for controlling the zoom function based on the second input.

16. A computer program product according to claim 15, wherein controlling the zoom function comprises changing the location of a centre of the zoom.

17. A computer program product according to claim 15, further comprising code for gradually slowing down the zoom function.

18. A computer program product according to claim 15, further comprising code for receiving information on removal of the first input after initiating the zoom function and keeping the zoom function active after the removal of the first input.

19. A computer program product according to claim 15, further comprising code for interrupting the zoom function in response to a third input.
